(19) United States
(12) Patent Application Publication
(10) Pub. No.: US 2002/0114909 A1
(43) Pub. Date: Aug. 22, 2002

(54) Combined hook and adhesive fastener with separate hook and adhesive covered regions

(76) Inventor: Salvatore F. Aiello, Franksville, WI (US)

Correspondence Address: S. Michael Patton, Nilles & Nilles, S.C., Firstar Center, Suite 2000, 777 East Wisconsin Avenue, Milwaukee, WI, 53202, US

(21) Appl. No.: 09/782,814

(22) Filed: Feb. 14, 2001

(51) Int. Cl. B32B 7/06

(52) U.S. Cl. 428/40.1; 428/43; 428/100

(57) ABSTRACT

A combined hook and adhesive fastener for use typically with vertical display materials has separate regions, one region having many hooks extending therefrom and another region having an adhesive layer. The hooks and adhesive may be located on the same part of the fastener on adjacent sections or they may be located on opposite sides of the fastener. By providing separate regions, the size of each region can be tailored for specific applications and is particularly useful when hanging display materials from fabric-covered walls since it permits an enlarged adhesive region and a reduced size hook region thereby permitting the more efficient use of hooks and adhesives. When the fastener is used in applications wherein they are under constant load, the adhesive covered region will usually be larger than the hook covered region since most common adhesives exhibit creep failure when under constant load, even a small constant load. The fastener has several optional features such as having a substrate with a pre-scored, sliced, or perforated region that is weaker and thus permits the hook fasteners to be torn away from the portion of the fastener having adhesive leaving the adhesive in place and eliminating the course and thick hook region. This permits easy stacking of display panels and reduces the chance that stacked display panels will be damaged.

### FIELD OF THE INVENTION

This invention relates generally to fastening devices that have two different fastening structures. More particularly, it relates to fasteners for vertically suspending display materials in exhibits.

### BACKGROUND OF THE INVENTION

Trade show exhibits are a multi-billion dollar business in the United States. In a typical trade show, there may be two or three hundred exhibitor's booths. Many of these booths are commonly constructed and assembled. They typically have cloth or felt covered panels that are directed vertically to form walls. These walls are covered with special advertising materials, such as paper posters, foam core panels, and poster board panels. These panels, which include advertising for the exhibitor, we will call “display materials” or “display panels” herein.

A common characteristic of these display materials and of the exhibition industry in general is that the exhibits are made for many different trade shows. They may be made larger, or smaller, but they are intended to be assembled rapidly and disassembled rapidly, packaged, and shipped. For this reason, most of the display materials are attached in a removable manner to the walls of the booth. For aesthetic reasons, the fasteners are typically applied to the backside of the panels and are made to engage and stick to the fabric walls of the booth. Since the booths are often reconfigured between trade shows, the display materials and the method of attaching them must be made so that the display materials can be attached to virtually any portion of the walls of the booth. For a large trade show, large display materials are suspended from the walls. For small trade shows, smaller display materials are suspended from the walls of the booth. If the booth is reduced in size by 50%, there will be some editorial decisions made regarding which of the display materials are most effective, or appropriate, for the particular audience the booth is intended to serve. Again, this requires a flexible attachment system.

Historically, one of the most common methods of attaching display materials to the walls of exhibition booths has been hook and loop fastener materials. These materials, such as are commercially made by 3M and called “Velcro®” have several useful characteristics. First, they provide a relatively large surface area with many hundreds of individual tiny plastic loops widely distributed across the surface area. Due to the small size of the tiny plastic loops, and their flexible structure, Velcro® hook fasteners can be applied virtually anywhere on the fabric covered display booth panels. When removed, unlike nails or large metal loops, the place they were attached on the booth typically shows no ill effects. Velcro® fasteners do not tear the fabric, nor leave holes once they have been removed. There may be a little fraying of the fabric, but this is usually minor and not noticeable. In addition, Velcro® type hook fasteners are relatively cheap. They are typically made by simultaneously weaving a flat substrate of fabric, while simultaneously weaving a much looser and larger layer of course plastic loops into the substrate. These loops are then subsequently cut to turn them into hooks.

For every square inch of hook type fabric, such as Velcro®, there are individual hooks. The weight supporting ability of these hooks is collectively substantial. A square inch of Velcro® type hook fastener can support several pounds applied to the fastener in a direction parallel to the woven substrate. This is true whether the hook fasteners are attached to the specially constructed loop material or are attached to a common fabric or felt type outer surface of a display booth.

The hook type fastener material used in the display industry is typically used in roll form. The hook fastener material is woven in strips of anywhere from typically a quarter-of-an-inch to an inch wide. The back of this material is covered with a high tack adhesive that is bonded to the woven fabric substrate of the hook material.

To protect the free surface of this adhesive, it is typically covered with coated release sheet or plastic film that is also in the form of a long strip. The material is then rolled up and placed commonly in a cardboard carton. The user pulls the end of the roll free, cuts it to length, peels the release material off the adhesive layer and sticks the long strip to the back of the display materials. The display materials are then lifted into place vertically and pressed against the fabric-covered walls of the booth.

While this is a convenient method and is used quite commonly in most trade show exhibits, it has significant drawbacks. The surface area covered with hooks is generally the same as the surface area covered with adhesive, Thus, the surface area of the adhesive bond to the display panel is the same as the surface area of the hook bond to the fabric-covered walls of the display booth. This is wasteful since there is usually no need for as much hook area as adhesive area.

This is a problem since the hook material is significantly more expensive than the adhesive material. Since hook material must be woven on special machines, loops formed, and then loops cut, relatively complicated machinery is needed to make the hook material. The adhesive that is applied to the reverse side of the hook material is much, much less expensive. Machines that can apply this adhesive material are relatively simple to build and maintain. They require neither complicated moving parts nor complex periodic maintenance.

To provide the most cost effective device, therefore, one would expect to reduce the size of the hook-type fastening material until it provided exactly the same holding power as the adhesive material with the same safety factor.

In the example provided above, the display panels are attached to an adhesive layer that is adhered to the woven substrate from which extends, in turn, the hook fasteners. The hook fasteners in turn are connected to the fabric-covered wall of the booth. If the supporting capacity of the adhesive was the same as the supporting capacity of the hook type fastening material, the optimum design of a fastener would be one in which there were equal areas of adhesive covered surface and of hook covered surfaces. Thus, the present design (FIG. 1A-1C) of adhesive/hook type fasteners where the adhesive surface area is the same as the hook covered surface area would be the most efficient design. This is not the case, however.

When display panels are supported on a booth wall using a combined hook/adhesive fastening device, there is either too much, or too little holding power for one or the other surfaces, either the hook covered surface or the adhesive covered surface. As an example, a one square inch patch of hook fastening material is capable of supporting indefinitely approximately 15 pounds of weight. With this weight applied to one square inch of hook fastener the fastener will not disengage from a fabric surface. A one square inch patch of adhesive, on the other hand, may support a much greater weight over the short term, a period of time measured in minutes. Over the long term, a period measure in hours, however, a one square inch patch of adhesive will only support a fraction of the weight that the hook fastener will that a one square inch area of hook fastener would support. This inability to support a constant load of more than a few pounds per square inch of adhesive surface area indefinitely is often experienced by people who design and manufacture display materials and exhibition booths. All it takes is about one square inch of hook type fasteners to support a four by eight foot sheet of display materials called “foam core”. Foam core is made of an interior layer (perhaps two-tenths of an inch thick) of foam material covered on its outer surfaces by stiff paper. Novice exhibition designers often place a single one-half square inch to one square inch patch of adhesive coated hook type fastening material on a four by eight sheet of foam core. This amount of hook type fastening material is easily enough to support a four by eight foot sheet of foam core.

Typically, the user peels the release sheet off the adhesive coated hook material and presses the adhesive covered side against the back surface of the foam core. This causes the hook fastener material to stick to the foam core. The user then lifts the foam core into position and presses it, and hence hook fastener material, against a fabric covered wall of an exhibition booth.

To a novice, this will appear sufficient. Unfortunately, within a matter of hours, the adhesive will gradually creep, as it is unable to resist the shear forces applied on the joint between the adhesive and the foam core.

In a matter of hours, the weight of the foam core acting in shear on the adhesive joint will eventually pull the joint apart. This commonly happens overnight when no one is in the exhibition area. The next morning, a novice exhibitor will see that all of his display panels have fallen to the ground leaving the adhesive covered hook fastener embedded in the fabric of the exhibition booth walls just as it was originally attached.

In the example above it was shown that an adhesive joint of a given area is weaker than a hook and loop joint of the same area. The converse is also true, strangely enough. If one applies an adhesive covered hook fastener to a sheet of foam core, and then presses the foam core against the fabric covered wall of the exhibition booth it will hang there. If one immediately pulls the foam core sheet away from the wall of the exhibition booth, the two will separate at the hook and loop joint and not at the adhesive joint. Thus, for rapid removal, the hook and loop joint is demonstrably weaker than the adhesive joint.

It should be clear, therefore, that an adhesive covered piece of hook and loop material with equal adhesive area and hook area is not necessarily the optimal, or most cost effective design.

To avoid the first problem, that of “creep” that causes the adhesive joint to separate over a matter of hours, builders of exhibits often go overboard, by using a great deal of hook fastener material. To ensure that the display panels do not fall off the walls of the booth overnight exhibit builders will often put ten or fifteen times the necessary amount of hook and loop fastening material on a single foam core panel. As I mentioned above, one square inch of hook fastener material is sufficient to support a four by eight foot sheet of foam core. Were it not for adhesive creep, this is all the hook type material that would be used. Because there is creep, many exhibitors will use five, ten or even fifteen square inches of adhesive covered hook fastening material to hold a panel of foam core against a booth wall. The reason this additional material is required is to reduce the per-unit-area load applied to the adhesive joint and not because the additional surface area of hook fasteners is required. It is common to see five, ten or even fifteen inches of a one-inch wide adhesive covered hook type material on a single panel of foam core.

This excessive application of hook type fastening material causes problems, however. As I mentioned above, exhibits must be taken down, packed, shipped, unpacked and reassembled regularly. Typical exhibition dates last no longer than two or three days. Only a few last as long as a week or ten days. Thus, in the course of a year, booths and their associated display materials are assembled and re-assembled many times. With each assembly and disassembly the possibility of damage increases. One particular source of damage is the scratching and scuffing caused by the hooks themselves. The more hook fastening material that is applied to a display panel, the more chance that display panels packed next to each other will get scratched by the rather stiff plastic hooks extending from the surfaces of the panel. This problem is compounded by the fact that so much hook type material is applied to each one of the panels that is hung from the exhibition booth walls. The more hooks, the more opportunity to damage panels. Furthermore, hook type fastening materials have a substantial thickness as compared to the display materials (typically poster board or foam core) to which they are attached and which they suspend from the booth walls. For example, Velcro®, a common hook fastening material sold by 3M, is about one-tenth of an inch thick. Foam core panels are about two-tenths of an inch thick. Stiff poster board panels are about eighty thousands of an inch thick. When booths are disassembled and packed, twenty foam core panels would stack to a height of about four inches. If the hook fastening material were left on each one of these boards, it would add an additional one-tenth of an inch to the thickness of each foam core panel. As a result, a stack of panels that could that would take up only four inches of thickness and be relatively rigid will take up approximately six inches in thickness (with the hook type fastening material) and, due to the gap between the stacked panels, will be very easily bent, creased or broken in two.

The answer to this problem would seem to be simple: pull off each patch of hook type fastening material from the display panels leaving the panels clean and one-tenth of an inch thinner than they normally would be. This, however, is not an easy process. As I explained above, the adhesive used on the prior art fasteners is very tenacious when one tries to remove it manually, such as whenever one peels off a patch of the hook type fastening material covered with adhesive. While the adhesive will generally pull apart under in the course of a few hours under the weight of the display panel, peeling it loose from the display panels in a matter of seconds will often shred the surface of the panel. The adhesive is so tenacious during rapid manual removal that it does not release from the display panel and will, instead, tear off the outer layer of the foam core. Foam core and poster board have outer surfaces made of paper. Removal of the hook type fastening material typically tears off a long ribbon of paper from the outer surface of the display panels. By removing the paper, the structural strength of the panels is reduced. It is difficult to remove the adhesive covered hook type material patches without damaging the display panel to which they are attached. As a result, most exhibitors leave the hook type fastening material on the display panels and make an extra effort to package the panels carefully. This, however is not a satisfactory solution.

What is needed, therefore, is an improved fastening device that can be applied to a fabric surface to support a display panel. This fastening device should be easily removed from the fabric of the of an exhibition booth wall without damaging the wall fabric.

The fastening device should be easily applied to the display panels and readily removed to permit stacking and shipping with limited damage. Furthermore, the device should provide for relatively easy removal without damaging the display panel. In addition, its structure should permit the different adhesive abilities of the different adhesion materials to be better matched for a particular application.

### OBJECTS AND SUMMARY OF THE INVENTION

It is an object of this invention to provide such an adhesive device solving in each of the preferred embodiments at least one of the foregoing problems.

In accordance with a first embodiment of the invention, an adhesive device having first and second sides is provided including a first sheet of material having a first side a second side and an edge and having a plurality of hook fasteners on at least one of its first and second sides, a second sheet of material having a first side a second side and an edge and having an adhesive coating at least on one of its first and second sides wherein the first edge of the first sheet and the first edge of the second sheet are joined to form a single unitary device having a first side and a second side the plurality of hook fasteners and the adhesive may be both on the first side of the adhesive device. The plurality of hook fasteners may be on first side of the adhesive device and the adhesive may be on the second side of the adhesive device. The plurality of hook fasteners may have a surface area on the first sheet of between 0.1 and 4.0 square inches. The hook fastener surface area may be between 0.2 and 2 square inches. The hook fastener surface area may also be between 0.3 and 1 square inches. The adhesive may have a surface area on the second sheet of between 0.4 and ten square inches. The adhesive surface area on the second sheet may be between 0.5 and 5 square inches. The adhesive surface area on the second sheet may be between 0.7 and 3 square inches.

In accordance with a second embodiment of the invention, an adhesive fastener is provided that has a substrate divided into first and second planar abutting portions. The first portion is covered with a plurality of hook fasteners formed integrally with the first portion and extending from a first side of the first portion. The second portion has a layer of adhesive that covers substantially the entire second portion on either the same or the opposite side of the substrate. The area covered by the hook fasteners may be between 0.1 and 4 square inches, 0.2 and 2 square inches or 0.3 and 1 square inches. The surface area of the adhesive on the second portion of the substrate may be between 0.4 and 10 square inches, 0.5 and 5 square inches or 0.7 and 3 square inches, respectively. The adhesive may be covered with a release sheet disposed to cover substantially the entire free surface of the adhesive. This release sheet may extend to opposing edges of the first substrate and may extend to one end of the substrate. The release sheet may have a scribe, crease, groove or cut extending from one side of the release sheet to an opposing side of the release sheet. This mark may extend across release sheet substantially parallel to and overlying a line dividing the hook covered first portion from the adhesive covered second portion. The adhesive on the second portion may be applied to the same side, or the opposite side of the substrate from as the side from which the hooks extend. The relative areas of the first portion and the second portion may be one-to-one. Alternatively, the ratio of the areas of the hook covered portion and the adhesive covered portion may be one-to-two, or one-to-five. The substrate may have a scribe, perforation, or groove sufficient to weaken the substrate and permit the hook covered portion to be torn loose without tearing off the adhesive covered portion. This scribe, perforation or groove preferably extends completely across the substrate between the hook covered portion and the adhesive covered portion. The hook-covered portion may have adhesive material on the side opposite the hook-covered side.

### BRIEF DESCRIPTION OF THE DRAWINGS

The present invention will become more fully understood from the following detailed description, taken in conjunction with the accompanying drawings, wherein like reference numerals refer to like parts, in which:

FIGS. 1A, 1B and 1C are front, edge and back views, respectively, of a prior art hook and adhesive fastener;

FIGS. 2A, 2B and 2C are front, edge and back views, respectively, of a combined hook and adhesive fastener in accordance with the present invention;

FIGS. 3A, 3B and 3C are front, edge and back views, respectively, of another embodiment of the present invention;

FIGS. 4A, 4B and 4C are front, edge and back views, respectively, of another embodiment of the invention wherein the adhesive layer covers a portion of the backside of the hook fastener portion;

FIGS. 5A, 5B and 5C are front, edge and back views, respectively, of another embodiment of the invention in which a release sheet has a score or cut;

FIG. 6 is a partial cross-sectional edge view of a wall panel covered with a fabric layer to which a display panel is vertically attached using a fastener in accordance with the present invention;

FIG. 7 is another cross-sectional edge view of a wall panel covered with fabric to which a display panel is attached in accordance with another embodiment of the invention wherein adhesive and hooks extend from the same side of the fastener;

FIGS. 8A, 8B and 8C are front, edge and back views, respectively, of the fastening device shown in FIG. 7;

FIGS. 9A, 9B and 9C are front, edge and back views, respectively, of the fastener of FIGS. 8A-8C and including a release sheet covering the adhesive layer; and

FIGS. 10A, 10B and 10C are front, edge and back views, respectively, of the embodiments of FIGS. 7, 8A, 8B, 8C, 9A, 9B and 9C but having a release sheet having an unattached portion extending over the hook fastener portion of the fastening device that is free and graspable by two fingers.

### DESCRIPTION OF THE PREFERRED EMBODIMENTS

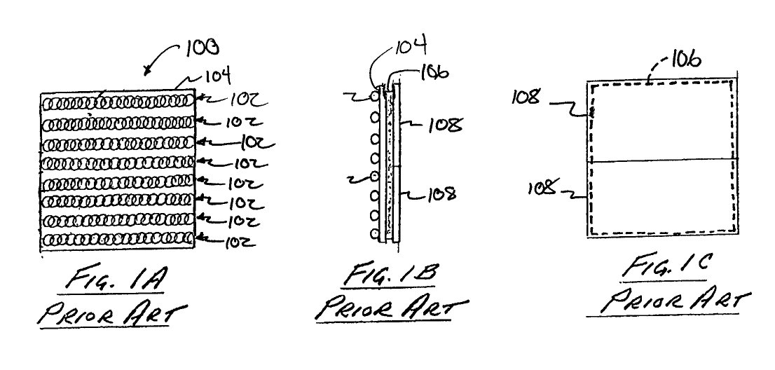

Referring now to FIGS. 1A-1C, an example of a prior art hook type fastener is shown in front, edge and rear views, respectively. FIG. 1A shows a typical square pad 100 with a plurality of woven plastic hooks 102. The fastener has a plurality of hooks extending from the front side, shown most clearly in FIG. 1A. It also has a backside to which an adhesive is applied. The hooks are woven into a substrate from a stiff plastic monofilament. The monofilament is stiff enough that it takes a permanent set after it is sewn. The loops, once set, are sliced along one side by automated machinery, thereby converting each loop into a hook. The substrate in which they are sewn is typically a woven fabric, woven of substantially smaller plastic thread than the loops and hooks themselves. This permits the substrate to be relatively flexible and the loops relatively rigid. Alternatively, the hooks may be molded integrally with the substrate 104 from which they extend.

Referring to FIG. 1B, which is an edge view of the fastener, one can see a thin adhesive layer 106 on the side of the fastener opposite the hooks. This adhesive typically coats the entire reverse side, the backside of the substrate, and thus has substantially the same surface area as the hook-covered side. A release sheet or layer 108 covers the adhesive layer. It is peeled off to expose the adhesive just before pad 100 is used.

In typical construction, the substrate and hooks are formed in a long ribbon. This ribbon, once coated with adhesive and a release sheet, is sliced at various intervals to provide hook and adhesive fastening pads of various lengths. Due primarily to the need to handle this long ribbon of hook material, there are usually short selvedges provided on either side of the woven substrate. These selvedges may or may not be covered with adhesive.

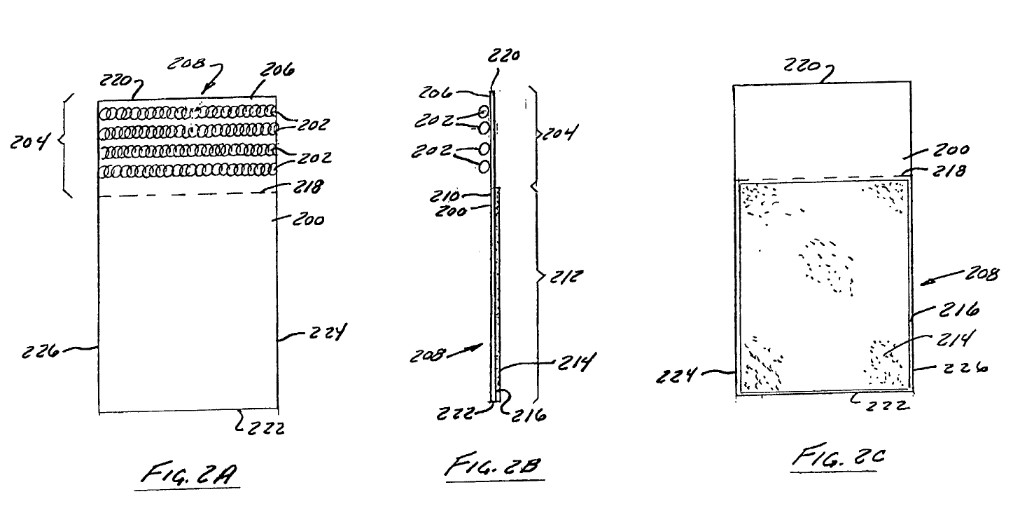

FIG. 2A illustrates a first embodiment of the invention, in which a thin planar substrate 200 has a plurality of rows 202 of hooks that form a hook covered region 204 at a first end 206 of a combined hook and/adhesive fastening device 208. FIG. 2B is an edge view of the fastener of FIG. 2A showing the hooks extending from a first planar side 210 of the device 208 the upper hook-covered portion 204 with its plurality of rows of hooks 202 and a lower adhesive covered portion 212. An adhesive layer 214 is applied to the adhesive covered portion of substrate the adhesive covered portion 212 of substrate 200 on an opposing side 216 of substrate 200. The adhesive layer 214 preferably extends substantially across the entire portion of portion 212 of the fastening device 208.

There are several distinct benefits to the embodiment of FIGS. 2A-2C. First, the relative areas of hook covered region 204 and adhesive covered region 212. In a preferred embodiment, the adhesive covered surface area of region 212 is preferably at least as large as the hook covered region 204. More preferably it is at least twice as large as region 204 and most preferably it is at least four times as large as region 204.

By providing a larger adhesive covered area, the average load per square unit area of adhesive is reduced. Enough hooks are provided to ensure the support of a suspended panel and enough adhesive is provided such that the phenomena of overnight “creep” and failure of the adhesive-to-display panel joint is substantially reduced.

Unlike prior art devices, the larger adhesive-to-hook area reduces the chance that the adhesive joint ratio will release while keeping the hook covered area small enough to support the panel but not excessive. In this manner, the long-term support ability of both the hooks and the adhesive portions are matched and the end user does not pay extra for un-needed hooks.

Another important benefit of the arrangement of FIGS. 2A-2C and completely separate from the benefits provided by a larger relative adhesive area is the fact that in this embodiment the hook covered region does not have an adhesive covered back. Since the back of the hook covered portion 204 is substantially free of adhesive, the hook covered portion can be lifted away from the back of a display panel and easily severed with a pair of scissors or a knife. Since the adhesive is not applied to the back side of the fastener directly opposed to the hooks, there is a reduced chance that lifting the hooks away from the surface will cause the surface of the display panel to tear.

The embodiment of FIGS. 2A-2C has an additional feature that will also assist in the removal of the hook covered portion 204. This feature is provided by the perforations 218 that extend across the widths of device 208 between the hook covered portion 204 and the adhesive covered portion 212. Depending upon the substrate, providing perforations such as these may will permit the user to merely lift the hook covered region 204 away from the back of the panel to which the device is secured and tear it off. Again, depending upon the substrate, perforations such as these would permit the hook-covered region to be removed without the use of a knife or pair of scissors.

Substrate 200 is preferably manufactured of a single unitary piece of material. In the preferred embodiment, it is a woven fabric, such as that described above in regard to FIGS. 1A-1C. The woven fabric is especially useful when supporting panels due to its significant strength. In the embodiment of FIGS. 2A-2C, it would be preferable woven with a selvedge formed along the length of top edge 220 and extending the width of the fastener, and along bottom edge 222 and extending across the width of the fastener. Opposing lateral edges 224 and 226 are preferably sheared edges and therefore preferably have a plurality of loose fiber ends extending therefrom. Substrate 200 need not be a woven fabric material, however. It can be, for example, stiff fibrous material such as paper, a solid plastic sheet having a thickness of between three thousandths and thirty thousandths of an inch.

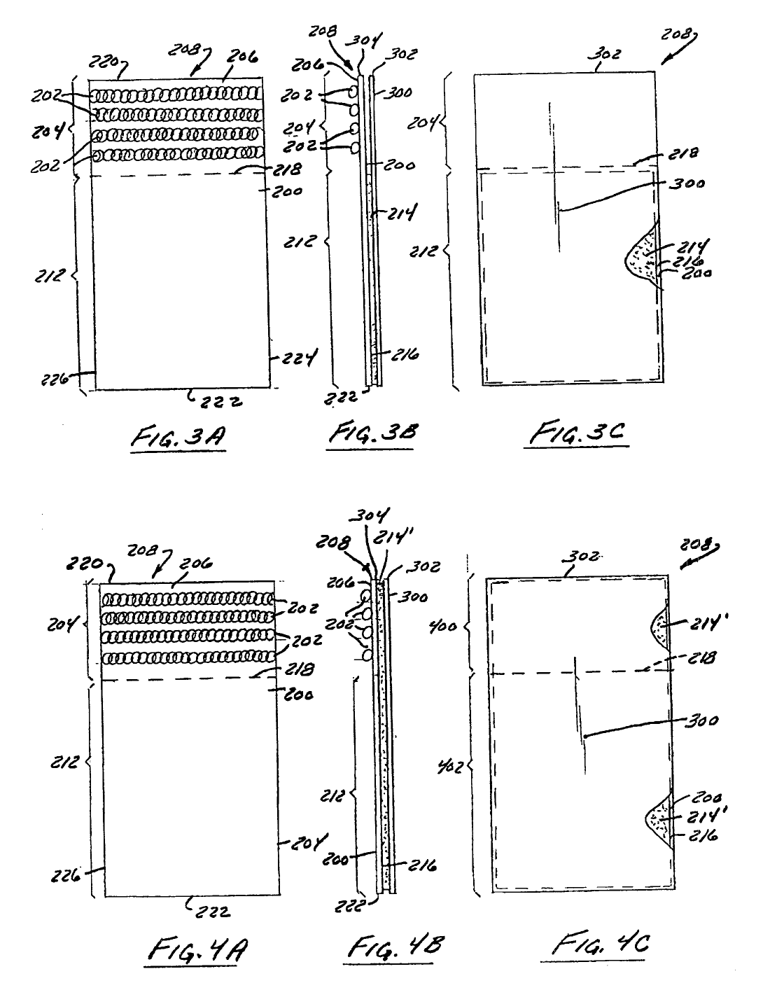

FIGS. 3A-3C show an alternative embodiment of the invention in which a release sheet 300 is adhered to the adhesive layer 214 and extends substantially across the entire adhesive layer. In this manner, the adhesive is covered and protected from contamination between manufacture and use. Note that the release sheet 300 extends substantially across the entire back of the fastening device, including areas in which it is not adhered to substrate 200, namely, covered area or region 204.

There are advantages to providing a release arrangement such as this. First, by providing a region in which the substrate is not bonded to the release sheet, the user can easily grasp upper portions 302 of the release material and upper portion 304 of the substrate, a part of hook covered region 204, and can pull these two apart. The release sheet 300 is selected such that when pulled apart in this manner, the adhesive will remain secured to substrate 200 and will release from the release material itself. The user, after pulling the release material off, will have a clean, smooth, fresh layer of adhesive that can be applied to the back of a display panel. In all other respects, the embodiment of FIGS. 3A-3C is the same as the embodiment of FIG. 2A-2C.

FIGS. 4A-4C show an alternative embodiment of the fastener in which the adhesive material covers substantially the entire reverse side of substrate 200. The embodiment of FIGS. 4A-4C is the same in all respects as the embodiment of FIGS. 2A-2C and FIGS. 3A-3C with the exception of the increased size of the adhesive layer. Referring now to FIGS. 4A-4C, and in particular to FIG. 4B, and edge view of the fastening device, note that the release sheet 300 still extends substantially across the entire area of substrate 200. Note, however, that the adhesive layer identified as 214 in FIGS. 2A-2C is here identified as 214′ and extends across entirely substantially the entire back surface of substrate 200. In all other respects the embodiment is the same as that of FIGS. 3A-3C.

Depending upon the need for support, the addition of an adhesive layer on the reverse side of portion 204, the hook covered portion of the device, will increase the supporting ability of the fastening device by permitting some overlap between the hook covered region and the adhesive covered region. In the preferred embodiment, the upper portion 400 of layer 214 will cover the entire hook covered portion 204 of the fastening device. In addition, portion 402 of the adhesive layer 214′ will cover substantially the entire non-hook covered portion of 212 of the fastening device.

In this embodiment of the invention, a fastening device is more appropriate for permanent installation on the back of a display panel. While the hook portion can still be peeled away from the display panel to which it is attached and, either cut off or torn off along perforations 218, this peeling of the hook covered portion can cause a panel of foam core or poster board to begin tearing as the portion 400 of the adhesive tears off the outer layers of the display panel. Nonetheless, if the display panel is not prone to tearing (for example if it is plastic) or the installation is intended to be permanent, this device has the advantage of a reduced size for a given area of adhesive. In short, hook covered non-hook covered region 212 of the fastening device can be reduced in size thus providing a more compact device and less expensive device by providing at least some of the adhesive on the back side of hook covered portion 204.

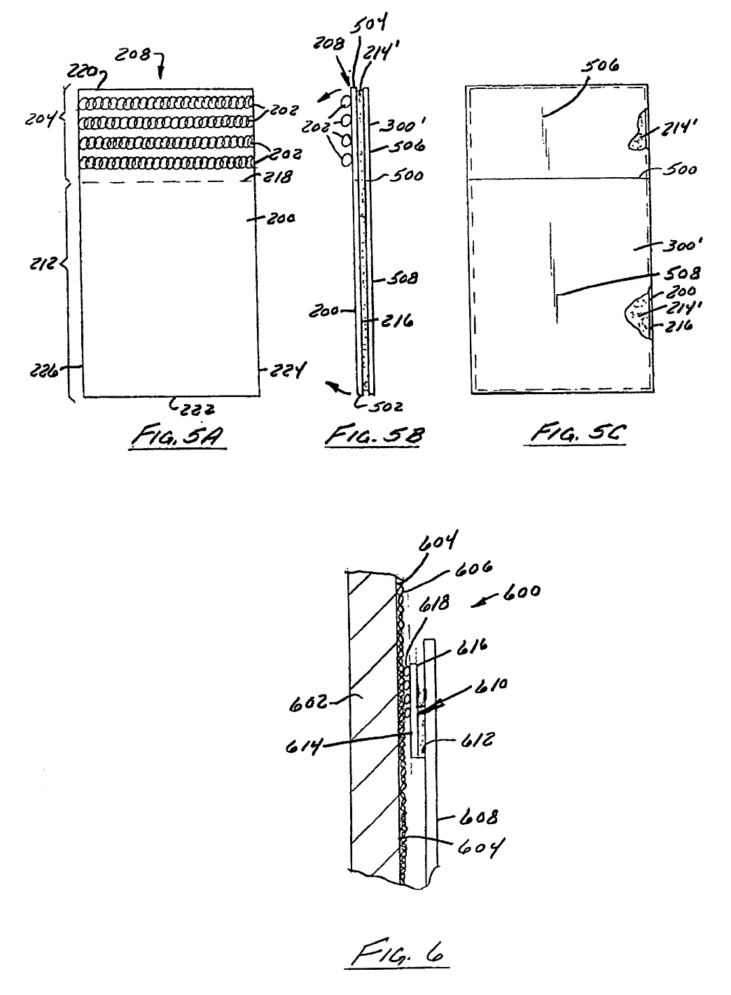

Removing the release sheet from the embodiment of FIGS. 4A-4C can be problematic. By providing adhesive over substantially the entire back surface, and depending upon the tenacity or adhesiveness of the adhesive, it may be very difficult for the user to get his fingernails between the release sheet and the adhesive layer in order to peel the release sheet off the device. For this reason, a variation of the fastening device of FIGS. 4A-4C has been devised and is shown in FIGS. 5A-5C in which the release sheet is scored, scribed or broken (item 500). Other than by the addition of this weakened section the embodiments of FIGS. 5A and 5C is the same as that of FIGS. 4A-4C.

Referring now to FIGS. 5A-5C, we can see the same embodiment of the fastening device shown in FIGS. 4A-4C but including a backing sheet 300′ that extends substantially across the entire back side of the fastening device. The backing paper 300 of FIGS. 4A-4C is designated 300′ in the embodiment of FIGS. 5A-5C due to the fact that it includes a scored line 500 that extends across the back side of the fastening device. In the preferred embodiment, line 500 is a scored or weakened portion of release sheet 300′ that will break apart when the device is flexed to put release sheet 300′ in tension. This is typically done by bending end portions 502 and 504 towards each other and away from the release sheet as indicated by the arrows at the top and bottom of the device shown in FIG. 5B.

If the adhesive that comprises layer 214′ in FIGS. 5A-5C is sufficiently tenacious, a typical plastic-coated paper release material may not be satisfactory. Tenacious adhesives can actually tear the release sheet apart. For that reason, if a tenacious or extremely adhesive material is used for adhesive layer 214′, it is preferably that release sheet 300′ be a stiff plastic and that line 500 be a cut that extends entirely through the release sheet 300′ thereby forming two separate pieces of release sheet. In effect, this means that release sheet 300′ can be provided in two separate portions: an upper portion 506 and an abutting adjacent portion 508 shown in FIG. 5C.

In the preceding examples described shown in FIGS. 1A-1C through 5A-5C, the fastening device had adhesive on one side of substrate 200 and hooks on the other side. These are the most preferred embodiments of the invention, since the typical application will be to attach the device to the backside of a display panel with adhesive and subsequently to press the hooks into the fabric covered wall of the display booth.

An example of this application is shown in FIG. 6 using the embodiment of the fastener shown in FIGS. 2A-2C and 3A-3C wherein the adhesive layer extends only partially across the backside of substrate 200.

Referring to FIG. 6, a portion of fabric covered display panel 600 is shown having a wall a structural wall portion 602 which may be hollow or solid, with an outer surface 604 covered by a layer of fabric 606 a display panel 608 is shown attached to fastening device 610 by adhesive layer 612. The adhesive layer 612, in turn, is adheres to fastener substrate 614 to which it transfers the weight of the display panel 608. The upper portion 616 of fastener 610 has several rows of hooks 618 that are mechanically engaged with fibers of fabric layer 606. One of the advantages of this arrangement is shown in FIG. 6. Since the fastening device has adhesive on one side and hook fasteners on the other, it can be attached to the back of display panel 606 such that it is completely hidden behind the display panel and therefore invisible to trade show visitors who are viewing the display panel. While only a single fastener is shown in FIG. 6, it is expected that, for most display panels, more than one would be required to suspend the panel in order to keep it from tilting to one side or the other.

This is not the only embodiment of the fastening device, however. Although it is the preferred embodiment and is expected to be the most popular, it is not necessary that the fastening device be completely hidden from view.

Referring now to FIG. 7, an alternative arrangement of a fastening device in accordance with the present invention and its relation to fabric covered panel and a display panel is shown. In the example of FIG. 7, the display panel 602 the wall panel 600 of the previous FIGURE is shown with its core 602 outer surface 604 and fabric covered outer layer 606 abutting the outer surface 604. A similar display panel 608 is shown resting against the fabric layer 606. In this case, unlike the example of FIG. 6, the fastening device is fixed to the outer surface of the display panel 606.

In the embodiment shown in FIG. 7, the adhesive layer 700 is bonded to substrate 702 on the same side from which hook fasteners 704 extend. The fastening device itself is visible since it is adhered to the outer surface of display panel 608. Nonetheless, it provides the same advantages as the embodiments of FIGS. 2A-2C through 5A-5C provide, namely the ability to have a larger adhesive area thus reducing “creep” and failure of the fastener by failure of the adhesive joint as well as the resultant reduced cost due to the smaller size of the hook area 706 from which hooks 704 extend and engage fabric layer 606. In addition, and unlike the prior art embodiments shown in FIG. 1, both the adhesive and the hook and loop material extend from the same side of the fastening device.

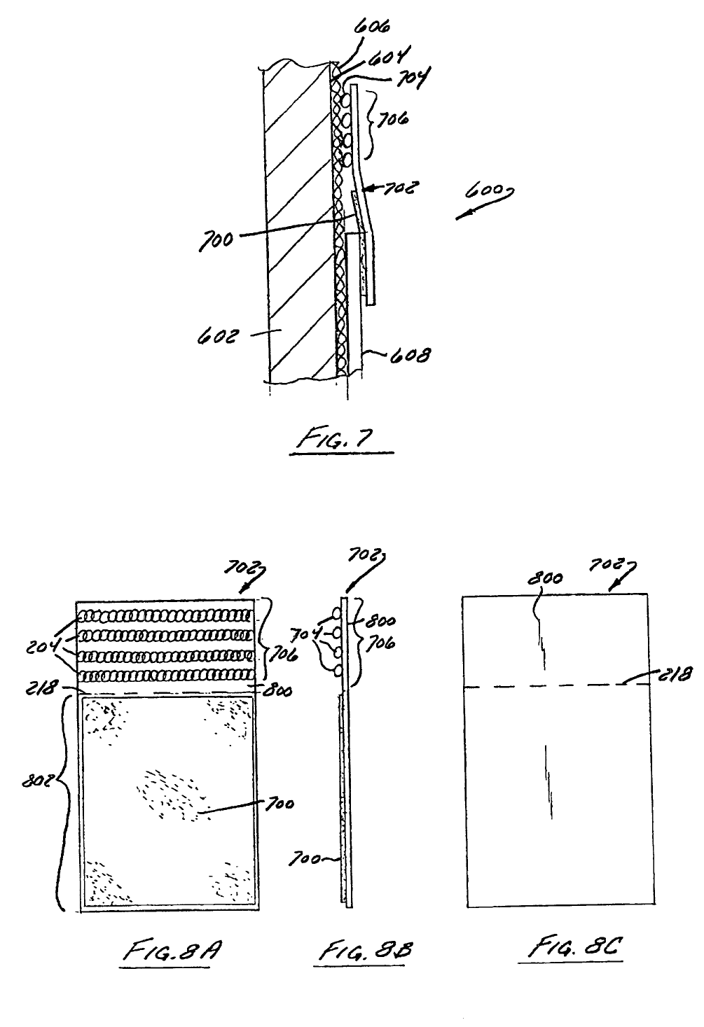

The fastening device illustrated in FIG. 7 is shown in more detail by itself in FIGS. 8A-8C. Referring now to FIGS. 8A-8C, a front edge and back view of the fastening device of FIG. 7 is shown. This device is identical to that shown in FIGS. 2A-2C with one difference. That difference is the location of the adhesive layer. In the embodiment of FIGS. 2A-2C the adhesive layer was shown on the opposite side of the substrate 200 as the hooks. In the embodiments of FIGS. 8A-8C the adhesive layer is on the same side as the hooks. In all other respects, the embodiment of FIGS. 8A-8C is the same as that shown in FIGS. 2A-2C.

A fastener 702 is shown having an adhesive layer 700 that extends across a first portion of 802 of substrate 800 covering substantially the that entire portion. A second portion 706 of substrate 800 is substantially entirely covered with a plurality of hook fasteners 704. These two portions preferably abut each other such that one entire side of the fastening device is covered either with adhesive or with hook type fasteners. As in the examples of FIGS. 2A-2C, fastener preferably has a perforated or scored region 218 that extends across the width of substrate 800 between the hook covered region and the adhesive covered region.

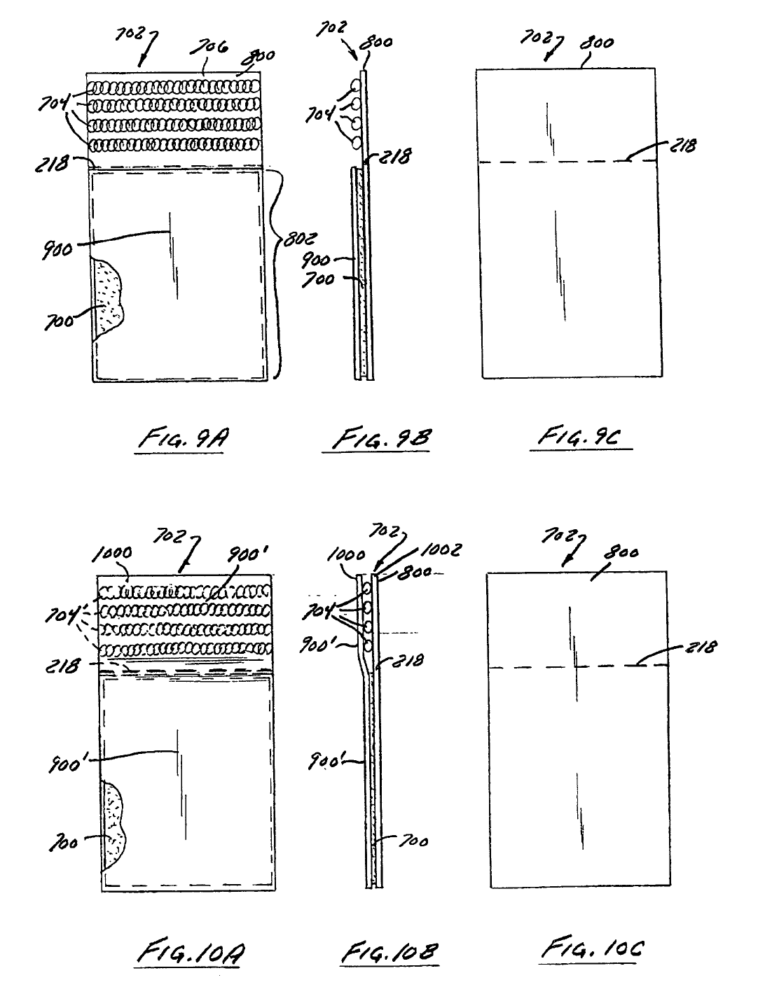

As in the case of the embodiments of FIGS. 2A-2C through 5A-5C, it is preferable that some release sheet be provided to cover the adhesive layer 700. Referring now to FIGS. 9A-9C, an embodiment of the fastening device in which the adhesive layer is covered is illustrated. The device of FIGS. 9A-9C is shown in which a release sheet 900 is provided. Release sheet 900 covers substantially the entire surface of adhesive layer 700 and thus protects substantially the entire surface from contamination between manufacturing and the end user. This construction is particularly advantageous as can be seen in FIG. 9B. Since the hook fasteners extend from the same surface that the adhesive and the release sheet are attached to, the overall effect is to provide a fastening device that has substantially a constant thickness. The additional thickness provided by the adhesive and the release sheet is roughly equal to the additional thickness provided by the hook fasteners and thus makes it easier to stack and package these devices.

Depending upon the type of adhesive used, whether more or less tenacious, it may be difficult to remove the backing paper due to the difficulty in getting one's fingernail between the release sheet and the adhesive layer. Since, as in the preceding examples, the release sheet extends to the lateral and bottom edges of the fastening device substantially coextensive with the substrate 800 along these edges, and since the adhesive also preferably extends to the lateral edges and to the bottom of substrate 800, it may be difficult to separate the release sheet from the adhesive. For that reason, another embodiment of the fastener may be fastening device may be particularly beneficial when dealing with tenacious adhesives.

Referring now to FIGS. 10A-10C, we have illustrated the fastener of FIGS. 9A-9C using a release sheet arrangement that is preferred when the adhesive is tenacious. In the embodiment of FIGS. 10A-10C, the release sheet extends over the top of the loop fasteners and is not bonded to them. By providing this unbonded portion of release sheet 900′, the user can more easily grasp and separate the release sheet from the fastener itself.

To do this, the operator would grasp the upper portion 1000 of the release sheet that is not bonded to the rest of the fastener with one hand, grab the upper portion 1002 of the substrate with another hand and pulling them apart. This will cause the release sheet 900′ to pull apart to pull away from the adhesive layer 700 starting at the junction 1004 of release sheet 900′ and adhesive layer 700 that is located closest to hook fasteners 704. A further advantage in providing a portion of the release sheet that covers the hooks but is not bonded to them, is that it makes the assembled fasteners including the release sheet be more easily stacked, sorted and packaged. By covering the hooks of the hook-covered portion, the fastener has two opposing substantially smooth surfaces with no protruding hooks or free adhesive surface to cause them to “stick” to other fasteners. They are much more easily guided through automatic assembly lines and can be packaged much tighter.

While the embodiments illustrated in the FIGURES and described above are presently preferred, it should be understood that these embodiments are offered by way of example only. The invention is not intended to be limited to any particular embodiment, but is intended to extend to various modifications that nevertheless fall within the scope of the appended claims.

What is claimed is:

1. An adhesive device having first and second sides, comprising:
a first sheet of material having a first side, a second side and an edge, and having a plurality of hook fasteners on at least one of its first and second sides; and
a second sheet of material having a first side, a second side and an edge, and having a adhesive coating on at least one of its first and second sides, wherein the first edge of the first sheet and the first edge of the second sheet are joined to form a single unitary device having a first side and a second side.

2. The device of claim 1, wherein the plurality of hook fasteners and the adhesive are both on the first side of the adhesive device.

3. The device of claim 2, wherein the plurality of hook fasteners is on the first side of the adhesive device and the adhesive is on the second side of the adhesive device.

4. The device of either of claim 2 wherein the plurality of hook fasteners has a surface area on the first sheet of between 0.1 and 4.0 square inches.

5. The device of claim 4, wherein the hook fastener surface area is between 0.2 and 2 square inches.

6. The device of claim 5, wherein the hook fastener surface area is between 0.3 and 1 square inches.

7. The device of claim 4, wherein the adhesive has a surface area on the second sheet of between 0.4 and 10 square inches.

8. The device of claim 7, wherein the adhesive surface area is between 0.5 and 5 square inches.

9. The device of claim 8, wherein the adhesive surface area is between 0.7 and 3 square inches.

10. An adhesive fastener having first and second sides, comprising:
a unitary substrate having a first planar portion and a second planar portion;
a plurality of hook fasteners bonded to the first portion of the substrate; and
an adhesive surface layer bonded to the second portion of the substrate.

11. The fastener of claim 10, wherein the plurality of hook fasteners is on the first side of the adhesive device and the adhesive layer is on the second side of the substrate.

12. The fastener of claim 11, wherein both the plurality of hook fasteners and the adhesive layer are on the second side of the substrate.

13. The fastener of either of claim 12 wherein the plurality of hook fasteners has a surface area on the substrate of between 0.1 and 4.0 square inches.

14. The fastener of claim 13, wherein the hook fastener surface area is between 0.2 and 2 square inches.

15. The fastener of claim 14, wherein the hook fastener surface area is between 0.3 and 1 square inches.

16. The fastener of claim 13, wherein the adhesive layer has a surface area on the second sheet of between 0.4 and 10 square inches.

17. The fastener of claim 17, wherein the adhesive layer surface area is between 0.5 and 5 square inches.

18. The fastener of claim 17, wherein the adhesive layer surface area is between 0.7 and 3 square inches.

19. The fastener of claim 10 wherein the plurality of hook fasteners are formed integrally with the first portion of the substrate.

20. The fastener of claim 19 further comprising a release sheet that covers the second portion of the substrate.

21. The fastener of claim 20 wherein the adhesive layer covers substantially entirely a first surface of the second portion of the substrate and a surface that is opposed to the first surface of the second portion of the substrate is substantially free of any hook fasteners.

22. The fastener of claim 21 wherein the release sheet extends from a first opposing edge of the second portion of the substrate to a first opposing edge of the second portion of the substrate.

23. The fastener of claim 10 wherein the substrate includes a weakened portion between the first and second portions.

24. The fastener of claim 23 wherein the weakened portion is perforated.

25. The fastener of claim 23 wherein the weakened portion is scribed.

26. The fastener of claim 23 wherein the weakened portion is cut.

27. The fastener of claim 20 wherein the release sheet includes a weakened portion extending from a first edge of the release sheet to an opposing edge of the release sheet.

28. The fastener in accordance with claim 20 wherein the release sheet includes at least two separate portions, and further wherein each of the at least two separate portions is separately adhered in an adjacent and abutting relationship to the second portion of the substrate.
